(19) United States
(12) Patent Application Publication
(10) Pub. No.: US 2004/0208553 A1
(43) Pub. Date: Oct. 21, 2004

(54) Method and apparatus for optical layer network management

(75) Inventors: Weiguo Yang, East Windsor, NJ (US); Zheng Zheng, Eatontown, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: Lucent Technologies Inc.

(21) Appl. No.: 10/188,681

(22) Filed: Jul. 3, 2002

(51) Int. Cl. H04B 10/20; H04J 14/00; H04J 14/02

(52) U.S. Cl. 398/54

(57) ABSTRACT

A method for optical layer management of an optical channel in an optical network includes inserting specific data patterns into a frame of an optical signal in the optical channel such that when a framing header is extracted from the optical signal, the specific data patterns are readily identifiable, the specific data patterns being indicative of respective line statuses of the optical channel. Additionally, a method for optical layer management of an optical channel in an optical network includes extracting a frame header from an optical signal in the optical channel and analyzing the optical signal for the presence of previously inserted specific data patterns, the specific data patterns being indicative of respective line statuses of the optical channel.

### CROSS REFERENCE TO RELATED APPLICATIONS

This patent application is related to U.S. patent application Ser. No. 09/803,301 filed Mar. 9, 2001, which is incorporated herein by reference in its entirety.

### FIELD OF THE INVENTION

This invention relates to the field of optical networks and, more specifically, to network management of optical networks.

### BACKGROUND OF THE INVENTION

All-optical, re-configurable networks promise high capacity and protected data connections at low cost through the elimination of unnecessary electro-optic interfaces and the higher efficiency of network resources usage. However, significant obstacles to the introduction of all-optical networks currently exist. For example, current performance monitoring in SONET network systems and the like is achieved by accessing individual recovered bits in the SONET frame header through the use of electro-optic interfaces. An optical signal is converted to an electrical signal for analysis and amplification and then regenerated as an optical signal. More specifically, SONET network systems and the like rely on bit-by-bit processing of overhead bytes to perform network maintenance tasks such as alarm surveillance, loss of frame (LOF) detection, loss of signal (LOS) detection, and the like. With the elimination of electro-optic interfaces in all-optical networks, alternative methods of performance monitoring are needed since digital regeneration performed electronically is no longer available and since bit-by-bit processing required by traditional embedded operations channels (EOCs) is also no longer desirable.

### SUMMARY OF THE INVENTION

The present invention advantageously provides optical layer network management based on the spectral recognition of protocol-specific features in the optical layer.

In one embodiment of the invention, a method for representing a line status of an optical channel in an optical network includes inserting specific data patterns into a frame of an optical signal in the optical channel such that when a framing header is extracted from the optical signal, the specific data patterns are readily identifiable, the specific data patterns being indicative of respective line statuses of the optical channel.

In another embodiment of the present invention, a method for identifying line statuses of an optical channel in an optical network includes extracting a frame header from an optical signal in the optical channel and analyzing the optical signal for the presence of previously inserted specific data patterns, the specific data patterns being indicative of respective line statuses of the optical channel.

In another embodiment of the present invention, a frame recognition and performance monitoring circuit includes, a demultiplexer for separating an inputted optical signal into different wavelength channels, a broadband optical detector for converting the optical signal into an electrical signal, a notch filter for extracting a frame header from the converted optical signal, a power detector for monitoring the power of the filtered, converted optical signal, and a timing/logic control unit for analyzing the filtered, converted optical signal for the presence of previously inserted specific data patterns, the specific data patterns being indicative of respective line statuses of an optical channel of the optical signal.

### BRIEF DESCRIPTION OF THE DRAWINGS

The teachings of the present invention can be readily understood by considering the following detailed description in conjunction with the accompanying drawings, in which:

FIG. 1 depicts a block diagram of a typical circuit used in SONET performance monitoring;

FIG. 2 graphically depicts the comparison of the spectral structure of a SONET framing sequence with that of a pseudo-random bit sequence of the same length with the frequency axis scaled to the data rate;

FIG. 3 depicts a block diagram of a SONET frame recognition and PM monitoring circuit;

FIG. 4 graphically depicts examples of data patterns that can be inserted into the frame of an optical signal in accordance with the present invention;

FIG. 5 depicts a block diagram of a SONET frame/data pattern recognition and performance monitoring circuit in accordance with the present invention; and

FIG. 6 depicts a block diagram of a timing/logic control unit suitable for use in at least the SONET frame recognition and performance monitoring circuit of FIG. 5.

To facilitate understanding, identical reference numerals have been used, where possible, to designate identical elements that are common to the figures.

### DETAILED DESCRIPTION OF THE INVENTION

The present invention advantageously provides a method and apparatus for optical layer network management based on the spectral recognition of protocol-specific features in the optical layer. Although the present invention will be described within the context of an optical signal utilizing SONET protocol, it will be appreciated by those skilled in the art that the present invention can be advantageously implemented in systems or on signals utilizing other such protocols.

FIG. 1 depicts a block diagram of a typical circuit used in SONET performance monitoring (PM). The SONET PM circuit 100 includes an optical wavelength demultiplexer 110, a broadband optical detector 120, an optical amplification chain 130 typically including a transimpedance amplifier (TIA) 140 and a limiting amplifier 150, a high speed clock and data recovery unit (CDR) 160, a deserializer 170, and a processing chip 180.

Briefly stated, the optical wavelength demultiplexer 110 separates an optical signal into different wavelength channels (λ₁-λₙ). Each optical channel is then detected by a broadband optical detector 120 typically a p-i-n detector (PIN) or an avalanche photo diode (APD). The optical to electrical converted signal is then sent through a broadband amplification chain 130 consisting of a TIA 140 and a limiting amplifier 150 before reaching the high speed CDR unit 160. After the clock and data have been recovered, to get access to individual bits of a high speed data stream (2.5-Gb/s or higher), a high speed digital de-serializer 170 converts the high speed serial data to lower speed parallel data, typically 622-Mb/s. The processing chip 180, typically a SONET framer or a SONET performance monitoring ASIC, generates the framing pulses and extracts performance monitoring indicators that SONET standards would require.

As depicted in the SONET PM circuit 100 of FIG. 1, performance monitoring in SONET systems requires conversion of the optical signal to an electrical signal. Furthermore, as the data rates increase, the components required for SONET PM will become more difficult to make and higher in cost. For example, while at 2.5-Gb/s data rate, optical detectors, transimpedance amplifiers, limiting amplifiers, CDRs, de-serializers and processing ASICs are all commercially available at moderate costs. At 10-Gb/s data rate, the components are still in the experimental phase and have a higher cost. At 40-Gb/s, although broadband optical detectors are available, broadband amplifiers at this rate are difficult to make and processing ASICs are hard to find.

The Applicants' invention includes a method and apparatus for performance monitoring that does not require access to recovered data or bit-by-bit processing, but is based on spectral recognition of protocol-specific features for optical layer network management of, for example, SONET networks, described below.

A Telecommunications Management Network (TMN) includes support for SONET network element (NE) operations and data networking. The technologies that can be used to implement the TMN are overhead channels, dedicated transmission links, packet data networks, or any combination of the three. From the all-optical networking aspects, the concept of TMN will be applicable.

Dedicated transmission links and packet data networks can be used to implement a TMN for all-optical networks. In particular, for example, the existing packet data networks that are carrying data traffic today can be used to implement the TMN for all-optical networks. Maintenance of a telecommunication network deals with issues such as alarm surveillance, performance monitoring, testing, and hardware control. These requirements are used to perform the maintenance tasks that include trouble detection, trouble or repair verification, trouble sectionalization, trouble isolation, and restoration. It is the aspects of alarm surveillance and performance monitoring that present significant challenges to all-optical networks, since in SONET these functions rely on the portion of the TMN that is physically implemented on the telecommunications network, more specifically, the overhead bytes of SONET frame that have to be bit-by-bit processed by NEs.

SONET alarm surveillance and performance monitoring are categorized according to SONET network layers namely, a Section layer, a Line layer, and a Path layer. Briefly stated, the Section layer deals with the signal regeneration. It has functions such as framing, scrambling, section error monitoring, and section level EOCs. Framing in a SONET network is described as imposing a structure to the data stream that is transmitted so that a meaningful bit sequence can be reconstructed by locating the start of a frame. The Line layer deals with functions such as cross-connect, time domain multiplexing (TDM), and protection switching. The Line layer provides synchronization and multiplexing as well as line error monitoring and Line level embedded operations channels (EOCs). The Path layer interfaces with client signals. Following SONET layered network structure, the Path level will be above the optical layer because dealing with client signals requires bit-by-bit processing and transfer of digital data calls for optical to electrical to optical (O/E/O) interfaces. Line level overhead dealing with the transport of the Path layer may have to be preserved, but the processing of these bytes will be above the optical layer. However, it is possible to implement some Section and Line level functions, such as alarm signaling and performance monitoring directly in the optical layer, and therefore perform all-optical networking functions such as wavelength multiplexing and protection switching without requiring full O/E/O interfaces.

SONET alarm surveillance specifies various failure states, alarm indication signals (AIS), and alarm related events and actions. NE failure states include Loss of Signal (LOS), Loss of Frame (LOF), Loss of Pointer (LOP), and various equipment failures such as power failures and CPU failures. SONET alarm indication signals (AIS) are specified at the Line layer, Path layer and client levels. AIS is used to alert downstream equipment that an upstream failure at its indicated level has been detected. Line AIS alerts downstream line terminating equipment (LTE) that a failure has been detected thus triggering corrective action such as protection switching.

Line Far End Receive Failures (FERF) are typically referred to and illustrated as yellow signals that are used to alert upstream terminals of a downstream failure at specific levels. While the path-related yellow signals are generally not a concern of the optical layer, Line FERF is useful for fault localization and isolation and therefore should be in some way incorporated in the optical layer. Upon detection of failure states or various AIS signals and Yellow signals, NEs will take specified actions ranging from alarm forwarding, initiating alarm timing circuits, and protection switching.

Various SONET PM parameters are defined at all levels of the layered data structure. Section layer PM includes frame loss second (FLS), coding violations (CVs) collected using the BIP-8 in the B1 byte in the Section overhead, and errored seconds (ESs) and severely errored seconds (SESs) built upon CV information. Except for the FLS, which can lead to a failure state, CVs and CV-based ES/SESs are essentially a measure of bit error rate (BER), which is the ultimate performance indicator for a digital bit stream. However, collecting CVs requires digital operation on the recovered overhead bytes, which will not be available at the intermediate nodes in an all-optical network. New methods of signal quality monitoring without requiring a full broadband O/E and CDR interface have to be used for the similar purposes in all-optical networks.

Line layer PM include signal quality related PM parameters such as Line CVs, Line ESs/SESs, and Line degraded minutes (DMs) derived from Line ESs/SESs. Line layer function related PM parameters include Line unavailable seconds (UASs), protection switching counts (PSCs), protection switching duration (PSD), and STS pointer justification counts (PJCs). Except for PJCs, which require bit-by-bit processing of the Line overhead, other Line layer function related PM parameters, namely UASs, PSCs and PSD, are available within the optical layer. PJC is a PM parameter reflecting the performance of client interface therefore does not have to be monitored in the optical layer. Other specified PM parameters are associated with the Path layer and higher client levels. These are, again, not concerns within the optical layer since the layers other than the optical layer will be equipped with broadband O/E and full CDR interfaces and therefore have access to bit-by-bit processing.

The optical layer operations, administration, and maintenance (OAM) requirements for all-optical networks can be summarized as follows: Optical layer network management for all-optical networks will be required to handle issues related to the Section layer and the Line layer with a modified Line layer dealing with the end-to-end connection of fiber path and wavelength channels. Path terminating equipment (PTE) in all-optical networks will be above the optical layer with full O/E/O interfaces and access to bit-by-bit processing. Therefore, OAM issues related to Path layer and higher client levels will not be handled in the optical layer. However, the optical layer should implement similar functions addressing the Section layer and the modified Line layer OAM requirements. These include alarm surveillance related items such as LOS, LOF, Line AIS, Line FERF, and PM related issues such as meter measurements, FLS, signal quality, UAS, PSCs, PSD, and reporting and communication with a surveillance OS. As such, methods of determining the alarm surveillance related items based on spectral analysis of optical signals are required for use in all-optical networks.

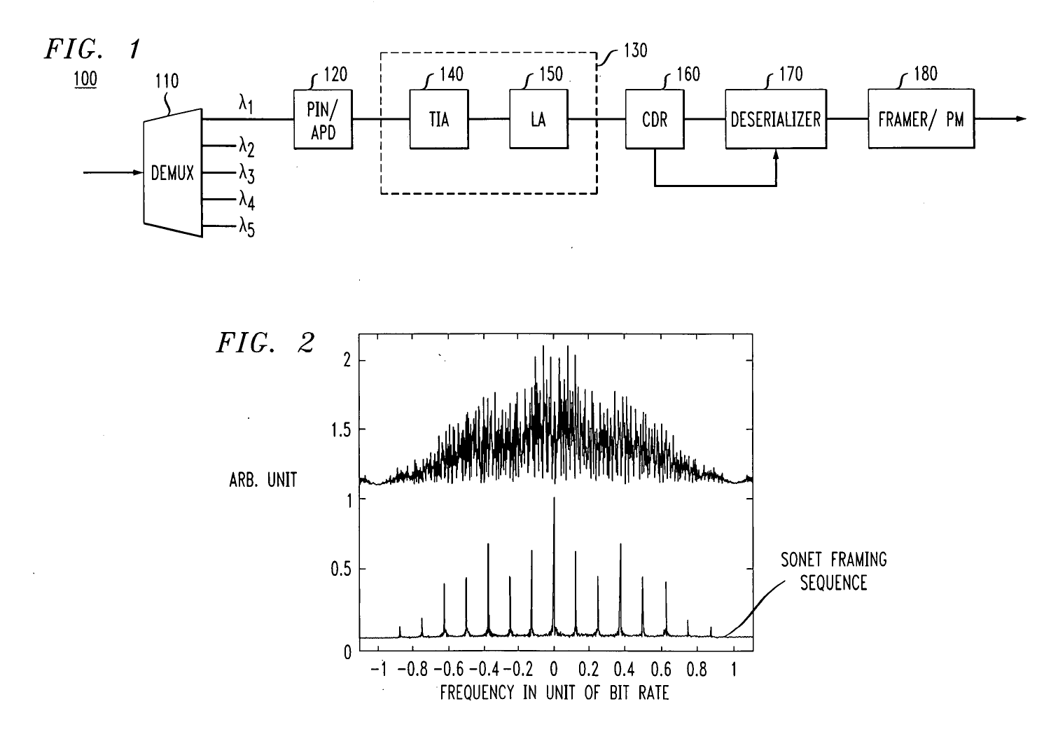

The inventors have discovered a method and apparatus for protocol feature recognition and signal quality PM, based on a SONET frame recognition and performance monitoring circuit disclosed in commonly-owned patent application Ser. No. 09/803,301 entitled “TECHNIQUE FOR MONITORING SONET SIGNAL”, which is incorporated herein by reference in its entirety. Briefly stated, a spectral analysis based protocol-aware PM method (SAPA-PM) utilizes an intrinsic data structure of SONET, namely the frame alignment header (FAH), which is a heavily repeated pattern for OC-N at data rates of 2.5 Gbps and higher. This heavy repetition in the time domain concentrates energy distribution in the spectral domain to a few discrete frequency positions within the interested modulation frequency range. The resulted spectral content is therefore fundamentally different from that of a more random bit sequence, whose energy is spread over the entire spectral range. FIG. 2 graphically depicts the comparison of a spectral structure of a SON ET framing sequence with that of a pseudo-random bit sequence of the same length with the frequency axis scaled to the data rate.

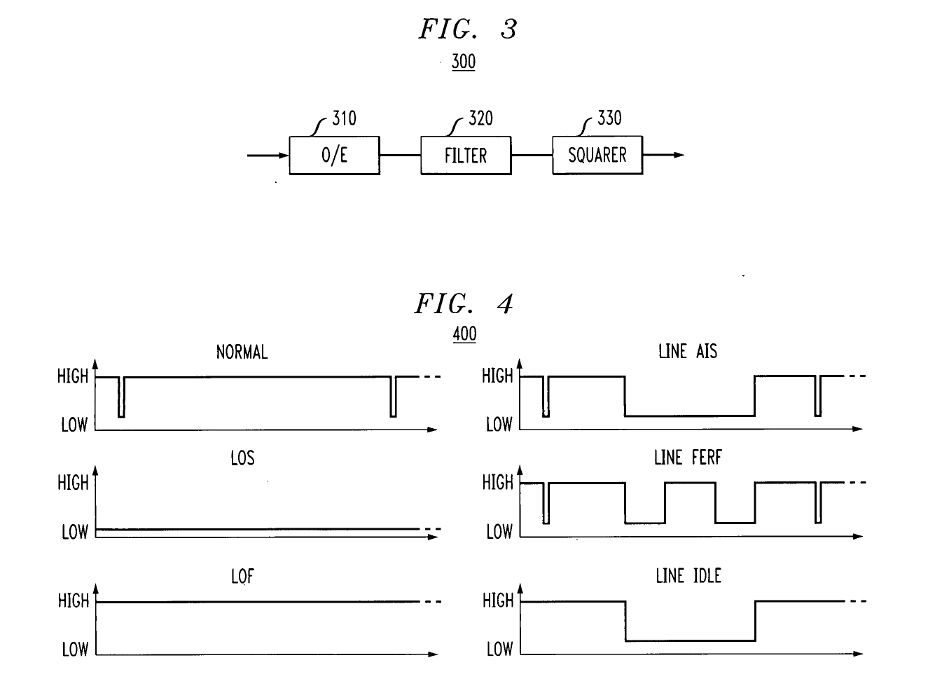

FIG. 3 depicts a block diagram of a SONET frame recognition and PM monitoring circuit as disclosed in the commonly-owned patent application Ser. No. 09/803,301 described above. In the system 300 shown in FIG. 3, an optical carrier (OC) received is first supplied to a standard optoelectronic apparatus 310, such as a PIN diode, that converts the optical signal to an electrical signal. This signal is then supplied to a notch filter 320 designed to filter out the repetitive framing signal while passing the noise associated with it remaining in its timeslot at lower power as well as the higher random data signal power.

The output of the filter 320 is then supplied to a square law detector 330 which further discriminates between the low power framing signal noise and the high power data signal so that, in a visual display of the result, there is readily recognized the framing signal noise and its level determined. Remedial action can then be taken when the framing signal noise is detected to be above some specified level.

As disclosed, filters are be applied to differentiate a FAH from the rest of the signal in the frame, which is random, such that only noise power will get through the filter during the time period of FAH, while during the rest of the frame, signal power will get through. Briefly stated, this method provides a set of PM indicators including LOS, LOF, signal quality, FLS, and Line UAS.

In accordance with the present invention, specific data patterns representing various performance monitoring parameters including LOS, LOF, signal quality, FLS, line UAS, and the like, are inserted into a frame of an optical signal to indicate a specific failure, such that subsequent spectral analysis in the optical layer of the optical signal detects the presence of the inserted data patterns indicating the associated failures. This is possible because, as demonstrative in a current SONET protocol, an AIS frame consists of mostly “1” bits in the header and payload before scrambling. However, only a few bits in the overhead section are required by the NEs to identify the AIS signal, and the rest of the data in the frame gives no additional information.

The proposed alarm signaling scheme is based on sending unscrambled, repetitive data pattern(s) in the frame of an optical signal. The unscrambled signal proposed herein will not manifest the problems previously associated with unscrambled signals of causing failures in a clock recovery circuit of a receiver due to the transmission of long streams of ones or zeros, because the data patterns to be inserted herein will be well-behaved and controlled signals and will not cause such failures. To keep in line with the current SONET protocol, the transmitted frame will consist of scrambled header bytes so that current SONET header byte processors can recognize the frame as an AIS signal. On the other hand, the rest of the modified frame will enable an optical protocol recognition circuit to identify the indicated channel status without accessing individual bits. In one embodiment of the invention, the clock signal or its close derivables are used to produce the data patterns since the clock signals are readily available in the optical layer.

Since SONET frame can accommodate more than one time period in which repetitive patterns can be inserted all optically without disturbing the overhead bytes, the length and position of these repetitive patterns in the frame can be readily identified by SAPA-PM scheme and can be utilized to signal and differentiate various states, like Line AIS and Line FERF. As an example, the alternative ones and zeros pattern for non-return-to-zero (NRZ) format and all ones pattern for return-to-zero (RZ) format, when lasting longer enough in time, are the special cases of these heavily repetitive patterns. They are actually clock signals (in RZ format case) or closely derivable from clock signals (in NRZ format case). Such an optical clock can be provided by an all-optical clock recovery circuit; another critical element for all-optical networks. With optical line functions such as wavelength and fiber path crossconnect, such optical clock patterns or their close derivables can be inserted or removed by optical line equipment. On the other hand, such patterns will be picked up by PM monitors without full O/E interfaces, and therefore can be used to serve line status signaling purposes such as Line AIS and Line FERF. Such frames can be generated similarly by inserting clock-only period(s) without disturbing Section and Line overheads with the help of available framing pulses to determine the correct timing. To distinguish between the AIS and FERF signals, the optical Line AIS can consist of one string of the clock-only pattern in its frame, while optical Line FERF have two separate clock-only periods. This would ensure the electrical interfaces to function properly while a simple digital timing circuit can distinguish various link statuses and fulfill the alarm timing purposes in the meantime.

FIG. 4 graphically depicts examples of data patterns that can be inserted into a frame of an optical signal and recognized by SAPA-PM in accordance with the present invention. The data patterns in FIG. 3 represent some of the various link statuses SAPA-PM can report including Normal, LOS, LOF, AIS, FERF, and Line Idle statuses. The Line AIS frame signal has a long clock-only pattern in the middle of the frame, while the Line FERF signal has two separate, shorter clock-only patterns. In the embodiment of the Line AIS and FERF depicted, no usable payload data can be transmitted over the fiber since the Line AIS and FERF interrupt the payload, though the Section and Line overheads are not disturbed. While SONET Line AIS behaves similarly, namely blocking the transmission of the payload, SONET Line FERF, when inserted, allows meaningful upstream data transmission while SONET Line AIS does not. Line FERF is initiated because a failure state of downstream NE, while Line AIS is initiated because of a failure state of upstream NE.

The suggested modification of the line level signaling scheme provides a very desirable feature of directional failure indications that would enable strong fault management in the optical layer. Furthermore, as depicted in FIG. 4, Line Idle can be signaled by sending a frame without the FAH as a clock-only pattern in part of the payload. This line status indicates that the monitored wavelength channel is not in use and is therefore available for provisioning new services. Various other data patterns or line statuses can be advantageously implemented in accordance with the present invention.

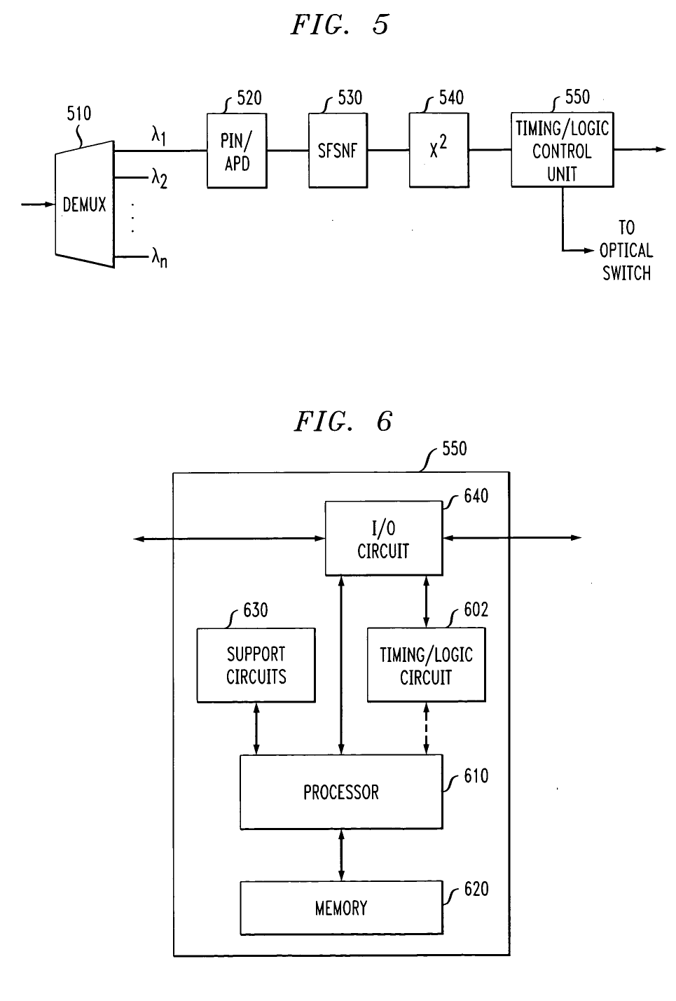

FIG. 5 depicts a block diagram of a SONET frame/data pattern recognition and performance monitoring circuit in accordance with the present invention. The SONET frame/data pattern recognition and performance monitoring circuit 500 includes an optical wavelength demultiplexer 510, an optical to electrical converter (illustratively a broadband optical detector) 520, a filter (illustratively a SONET framing signature notch filter SFSNF) 530, an RF power detector 540, and a timing/logic control unit 550. The SONET frame recognition and performance monitoring circuit 500 is still a per-channel-based scheme as seen in the SONET PM circuit 100 of FIG. 1, wherein the demultiplexer (DMUX) is still used to separate the optical signal into different wavelength channels. An optical signal from an optical channel in a communication system is tapped and routed as an input to the SONET frame/data pattern recognition and performance monitoring circuit 500. The optical signal is then converted to an electrical signal by the broadband optical detector 520. The SONET frame/data pattern recognition and performance monitoring circuit 500 of FIG. 5, however, does not require broadband amplifications, the high speed CDR, the high speed de-serialization, or high capacity processing ASICs as previously required in SONET PM circuits as the one depicted in FIG. 1. This is made possible by realizing that the SONET framing sequence, which always lasts about 308-ns regardless of the data rates, has a spectral structure that is fundamentally different from that of the rest of the SONET frame.

The signal is then input into the SFSNF 530 and the SONET framing sequence is substantially notched out. The power of the filtered signal is then detected by the RF power detector 540. In this way, not only the framing signal is detected as the power drop during the framing sequence (lasting about 308-ns), but also the RF power difference between the framing sequence and the rest of the frame is detected and utilized to reflect the electrical power signal-to-noise ratio (SNR), which is a desired channel quality indicator.

After the signal power is detected by the RF power detector 540, the signal then propagates through the timing/logic control unit 550. The timing/logic control unit 550 receives the filtered signal and analyzes the signal for recognition of the specific data patterns representing the various line statuses discussed above. The timing/logic control unit 550 recognizes the specific data patterns by comparing the received signal to stored data patterns within a memory in the timing/logic control unit 550. In another embodiment of the invention, the timing/logic control unit 550 can recognize the specific data patterns through analysis of the signal itself, by monitoring the change in logic levels or other well-known methods. In accordance with the present invention, the output of the timing/logic control unit 550 can be utilized to trigger corrective action in a system, trigger various alarms in a system, or to re-insert the data patterns into the optical signal of a system to indicate the appropriate line statuses of a system for subsequent analysis of the optical signal. In order to insert the data patterns into the optical signal of the system, an apparatus such as an optical switch is implemented at a node in the system and a timing output of the timing/logic control unit 550, representing the line statuses of a system, is used as an input to the optical switch.

FIG. 6 depicts a block diagram of a timing/logic control unit 550 suitable for use in at least the SONET frame/data pattern recognition and performance monitoring circuit 500 of FIG. 5. The timing/logic control unit 550 of FIG. 6 comprises a timing/logic circuit 602, a processor 610 as well as a memory 620 for storing data patterns, instructions and control programs. The processor 610 cooperates with conventional support circuitry 630 such as power supplies, clock circuits, cache memory and the like as well as circuits that assist in executing the software routines stored in the memory 620. As such, it is contemplated that some of the process steps discussed herein as software processes may be implemented within hardware, for example, as circuitry that cooperates with the processor 610 to perform various steps. The timing/logic control unit 550 also contains input-output circuitry 640 that forms an interface between the various functional elements communicating with the timing/logic control unit 550. For example, the input-output circuitry 640 can be used to send a timing output to an optical switch for inserting specific data patterns representing line statuses into the frame of an optical signal in an optical channel of an optical network.

Although the timing/logic control unit 550 of FIG. 6 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

In another embodiment of the present invention, the data patterns representing the line statuses can occupy different positions within the frame of an optical signal.

While the forgoing is directed to various embodiments of the present invention, other and further embodiments of the invention may be devised without departing from the basic scope thereof. As such, the appropriate scope of the invention is to be determined according to the claims, which follow.

What is claimed is:

1. A method for representing a line status of an optical channel in an optical network, comprising:
inserting specific data patterns into a frame of an optical signal in said optical channel such that when a framing header is extracted from the optical signal the specific data patterns are readily identifiable, said specific data patterns being indicative of respective line statuses of said optical channel.

2. The method of claim 1, wherein said optical signal is a return-to-zero formatted signal.

3. The method of claim 2, wherein said data patterns are clock signals.

4. The method of claim 3, wherein said clock signals are provided by a clock recovery circuit of said optical network.

5. The method of claim 1, wherein said optical signal is a non-return-to-zero formatted signal.

6. The method of claim 5, wherein said data patterns are derivable from clock signals.

7. The method of claim 6, wherein said clock signals are provided by a clock recovery circuit of said optical network.

8. The method of claim 1, wherein said line statuses are statuses selected from the group consisting of a normal status, loss of signal status, loss of frame status, line alarm indication signal, line far end receive failure signal, and line idle signal.

9. A method for identifying line statuses of an optical channel in an optical network, comprising:
extracting a frame header from an optical signal in said optical channel; and
analyzing said optical signal for the presence of previously inserted specific data patterns, said specific data patterns being indicative of respective line statuses of said optical channel.

10. The method of claim 9, wherein said optical signal is a return-to-zero formatted signal.

11. The method of claim 10, wherein said data patterns are clock signals.

12. The method of claim 11, wherein said clock signals are provided by a clock recovery circuit of said optical network.

13. The method of claim 9, wherein said optical signal is a non-return-to-zero formatted signal.

14. The method of claim 13, wherein said data patterns are derivable from clock signals.

15. The method of claim 14, wherein said clock signals are provided by a clock recovery circuit of said optical network.

16. The method of claim 9, wherein said line statuses are statuses selected from the group consisting of a normal status, loss of signal status, loss of frame status, line alarm indication signal, line far end receive failure signal, and line idle signal.

17. A frame recognition and performance monitoring circuit, comprising:
a demultiplexer for separating a received optical signal into different wavelength channels;
a broadband optical detector for converting the optical signal into an electrical signal;
a notch filter for extracting a frame header from the converted optical signal;
a power detector for monitoring the power of the filtered, converted optical signal; and
a timing/logic control unit for analyzing said filtered, converted optical signal for the presence of previously inserted specific data patterns, said specific data patterns being indicative of respective line statuses of an optical channel of said optical signal.

18. The frame recognition and performance monitoring circuit of claim 17, further comprising an optical switch.

19. The frame recognition and performance monitoring circuit of claim 18, wherein a timing output of the timing/logic control unit, indicative of the line statuses, of the optical channel, is used as an input to the optical switch, wherein said optical switch is a node for the optical channel, such that said specific data pattern is re-inserted into a frame of the optical signal in the optical channel.

20. A timing/logic control unit, comprising:
a memory for storing data patterns, instructions and control programs;
a processor, upon executing said instructions, configured to:
analyzing a filtered optical signal for the presence of previously inserted specific data patterns, said specific data patterns being indicative of respective line statuses of an optical channel of said filtered optical signal.

21. The timing/logic control unit of claim 20, further configured to:
outputting timing signals indicative of the line statuses of the optical channel, for use as an input to an optical switch, wherein said optical switch is a node for the optical channel, such that said specific data pattern is re-inserted into a frame of the optical signal in the optical channel.
